(19) United States
(12) Patent Application Publication
(10) Pub. No.: US 2012/0090485 A1
(43) Pub. Date: Apr. 19, 2012

(54) LATERAL REGISTER CORRECTING DEVICE, PRINTING PRESS, AND LATERAL REGISTER CORRECTING METHOD

(75) Inventors: Yoshio Nitta, Hiroshima (JP); Kazunori Ikeda, Hiroshima (JP)

(73) Assignee: MITSUBISHI HEAVY INDUSTRIES PRINTING & PACKAGING MACHINERY, LTD,, Mihara-shi (JP)

(21) Appl. No.: 13/378,155

(22) PCT Filed: Jun. 24, 2010
(86) PCT No.: PCT/JP2010/060764

§ 371 Date: Dec. 14, 2011

(30) Foreign Application Priority Data
Jun. 25, 2009 (JP) 2009-151217

(51) Int. Cl. B41F 13/56; B41F 21/00

(52) U.S. Cl. 101/227; 101/481

(57) ABSTRACT

A lateral register correcting device is capable of correcting register movement for a web by printing units. A register mark is printed on front and back sides of the web. A register correction control unit automatically controls a register correcting mechanism in real time based on a register correction amount derived by a pair of register cameras for detecting the register mark. A fan out correction control unit automatically controls a roller pressing mechanism in real time based on a fan out correction amount derived by a pair of fan out cameras for detecting the register mark.

### RELATED APPLICATIONS

The present application is a National Phase of International Application Number PCT/JP2010/060764, filed Jun. 24, 2010 and claims priority from, Japanese Application Number 2009-151217, filed Jun. 25, 2009.

### FIELD

The present invention relates to a lateral register correcting device, a printing press, and a lateral register correcting method in which register movement for a web caused by a plurality of printing units is corrected and a width of the web stretched in a width direction is corrected.

### BACKGROUND

As a lateral register correcting device of this type, there has been conventionally known a web paper lateral adjustment device including: a pressing mechanism for pressing web paper from one side thereof; a first moving mechanism which is linked with the pressing mechanism and provided for moving the pressing mechanism forward or backward with respect to the web paper; and automatic control means linked with the first moving mechanism (for example, see Patent Literature 1). An automatic control device in this web paper lateral adjustment device is linked with input means such as numerical keypad, detection means for obtaining information regarding a traveling speed of web paper, detection means for obtaining information regarding a misalignment amount of printing image in web paper, etc. Therefore, when the information regarding a traveling speed of web paper, the information regarding a misalignment amount of printing image in web paper, and the like, are inputted to the automatic control device, the automatic control device controls the first moving mechanism based on such information and the like so as to move the pressing mechanism forward or backward.

### CITATION LIST

### Patent Literature

Patent Literature 1: Japanese Examined Patent Application Publication No. Hei. 8-454

### SUMMARY

### Technical Problem

Multicolor color printing can be performed on a web by a plurality of printing units. Here, when a predetermined print image is printed on the web by each of the printing units, there may be a case in which the print image is not printed on a predetermined area on the web, thereby resulting in misalignment of the print image printed on the web. That is, register movement for the web by each printing unit may possibly occur. In this case, in order to correct the register movement, each printing unit prints register marks on a front side and a back side of the web. Then, image recognition of this register mark is performed by a camera, or the like, it is determined whether or not the image-recognized register mark is positionally shifted from a reference position, and each printing unit is adjusted in a width direction or in a paper flowing direction by an amount equal to the positional misalignment. Thus, the register movement can be corrected.

On the other hand, a state such that a web is being stretched in the width direction is called fan out. If fan out occurs, the web is being stretched in the width direction, thereby possibly failing to print a print image on a predetermined area on the web and resulting in misalignment of the print image printed on the web. In this case, fan out needs to be corrected. However, since fan out is typically corrected based on a web printing speed, and the like, if a printing condition other than the printing speed was changed, it has been difficult to suitably correct fan out occurring in the web.

Thus, the present invention aims at providing a lateral register correcting device, a printing press, and a lateral register correcting method in which register movement for a web by each printing unit is corrected in real time and a width of the web stretched in the width direction is corrected in real time based on register marks printed on the web, thereby suitably suppressing an occurrence of print misalignment.

### Solution to Problem

According to an aspect of the present invention, a lateral register correcting device including: a register correcting unit capable of correcting register movement for the web by each of the printing units, when a plurality of printing units print on a traveling web; and a fan out correcting unit capable of correcting a width of the web stretched in a width direction, wherein a register mark for performing correction by the register correcting unit and the fan out correcting unit is printed on the web by each of the printing units. The lateral register correcting device comprising: a register detection and estimation unit capable of estimating and detecting a register correction amount by the register correcting unit based on the register mark; a register correction control unit capable of automatically controlling the register correcting unit in real time based on the register correction amount derived by the register detection and estimation unit; a fan out detection and estimation unit capable of estimating and detecting a fan out correction amount by the fan out correcting unit based on the register mark; and a fan out correction control unit capable of automatically controlling the fan out correcting unit in real time based on the fan out correction amount derived by the fan out detection and estimation unit.

Please delete paragraphs [0009]-[0042] and insert the contents of paragraphs [0009]-[0042] into last of the Description of Embodiments.

According to this configuration, based on the register marks printed on the web, register movement for the web by each printing unit can be corrected in real time, and the width of the web stretched in the width direction can be corrected in real time. Thus, it is possible to suitably suppress the occurrence of print misalignment for the web.

Advantageously, in the lateral register correcting device, the register mark is printed on a front side and a back side of the web.

According to this configuration, based on the register marks printed on the front side and the back side of the web, register movement for the web by each printing unit can be corrected in real time, and the width of the web stretched in the width direction can be corrected in real time.

Advantageously, in the lateral register correcting device, the register detection and estimation unit includes a pair of register cameras which are disposed on the front side and the back side of the web with the web interposed therebetween and capable of detecting the register mark, and a register correction amount deriving unit that derives the register correction amount from the register mark detected by each of the pair of register cameras, and the fan out detection and estimation unit includes a pair of fan out cameras which are disposed so as to face the web and capable of detecting the register mark, and a fan out correction amount deriving unit that derives the fan out correction amount from the register mark detected by each of the pair of fan out cameras.

According to this configuration, the pair of register cameras detect the register marks printed on the front side and the back side of the web, respectively, and based on the detected pair of register marks, register movement by each printing unit can be corrected. Thus, register movement can be corrected with high accuracy.

Moreover, the pair of fan out cameras detect the pair of register marks printed on the web, respectively, and based on the detected pair of register marks, the width of the web stretched in the width direction can be corrected. Thus, fan out can be corrected with high accuracy.

Advantageously, in the lateral register correcting device, the pair of fan out cameras is disposed on the front side and the back side of the web with the web interposed therebetween.

According to this configuration, by disposing the pair of fan out cameras on the front side and the back side, when one-side color printing is performed on the web, for example, fan out can be corrected by using one of the fan out cameras. Thus, the versatility thereof can be increased.

Advantageously, in the lateral register correcting device, the pair of fan out cameras are disposed so as to face each other on a side of the web.

According to this configuration, by disposing the pair of fan out cameras on one side, when duplex color printing is performed on the web, for example, fan out can be corrected by using the pair of fan out cameras on one side of the web. Thus, correction can be performed with high accuracy.

Advantageously, in the lateral register correcting device, the pair of fan out cameras is disposed on both end sides of the web in the width direction, and the pair of register cameras are disposed between the pair of fan out cameras.

According to this configuration, the pair of fan out cameras can be disposed at both end sides of the web where the influence of fan out is large. Therefore, based on the pair of register marks printed on the both end sides of the web, fan out having a large influence can be corrected. Thus, fan out can be suitably corrected.

Advantageously, in the lateral register correcting device, the pair of register cameras is positioned at a substantially same position in the width direction of the web.

According to this configuration, the pair of register cameras disposed on the front side and the back side of the web with the web interposed therebetween can be disposed at substantially the same position in the width direction of the web. Thus, it is possible to correct register movement on the front side of the web and that on the back side of the web using the same condition. Thus, it is possible to suitably correct the register movement on the front side and the back side of the web. Moreover, by disposing the pair of register cameras at substantially the same position in the width direction on the front side and the back side, it is possible to perform correction in a manner such that a fan out correction amount derived by using the fan out camera disposed on one side of the web is equal to that about the other side of the web. That is, fan out correction amounts on the front side and the back side of the web can be made equal to each other. Thus, fan out can be corrected with high accuracy.

Advantageously, in the lateral register correcting device, the pair of register cameras is disposed on a center side of the web in the width direction.

According to this configuration, the pair of register cameras can be disposed on a center side of the web in the width direction where the influence of fan out is small. Therefore, based on the pair of front side and back side register marks printed on the center side of the web, register movement can be corrected. Thus, register movement can be suitably corrected without suffering from an influence due to fan out.

Advantageously, in the lateral register correcting device, the register detection and estimation unit includes a pair of register cameras which are disposed on the front side and the back side of the web with the web interposed therebetween and capable of detecting the register mark, and a register correction amount deriving unit that derives the register correction amount from the register mark detected by each of the pair of register cameras, and the fan out detection and estimation unit includes a fan out camera which is disposed so as to face the web and capable of detecting the register mark, and a fan out correction amount deriving unit that derives the fan out correction amount from the register mark detected by the fan out camera.

According to this configuration, the pair of register cameras detect the register marks printed on the front side and the back side of the web, respectively, and based on the detected pair of register marks, register movement by each printing unit can be corrected. Thus, register movement can be corrected with high accuracy. Moreover, the fan out camera detects the register mark printed on the web, and based on the detected register mark, the width of the web stretched in the width direction can be corrected. Here, since only one fan out camera needs to be disposed, the configuration of the lateral register correcting device can be simplified.

Advantageously, in the lateral register correcting device, the fan out camera is disposed at one end side of the web in the width direction, and the pair of register cameras are disposed on a center side of the web in the width direction.

According to this configuration, the fan out camera can be disposed at the end side of the web in the width direction where the influence of fan out is large, and the pair of register cameras can be disposed at the center side of the web in the width direction where the influence of fan out is small. Therefore, based on the register mark printed on one end side of the web, it is possible to suitably correct fan out having a large influence. Moreover, since register movement can be corrected based on the pair of front side and back side register marks printed on the center side of the web, register movement can be suitably corrected without suffering from an influence due to fan out.

Advantageously, in the lateral register correcting device, the fan out detection and estimation unit includes a pair of fan out cameras which are disposed so as to face one side of the web and capable of detecting the register mark, and a fan out correction amount deriving unit that derives the fan out correction amount from the register mark detected by each of the pair of fan out cameras, and the register detection and estimation unit includes a register camera which is disposed so as to face the other side of the web and capable of detecting the register mark, and a register correction amount deriving unit that derives the register correction amount from the register mark detected by each of the register camera and the pair of fan out cameras.

According to this configuration, the pair of fan out cameras detect the pair of register marks printed on one side of the web, and based on the detected pair of register marks, the width of the web stretched in the width direction can be corrected. Thus, it is possible to correct fan out with high accuracy. Moreover, the register camera detects the register mark printed on the other side of the web, and based on the register mark detected by the register camera and the pair of register marks detected by the pair of fan out cameras, register movement by each printing unit can be corrected. Here, since only one register camera needs to be disposed, the configuration of the lateral register correcting device can be simplified.

Advantageously, in the lateral register correcting device, the pair of fan out cameras is disposed on both end sides of the web in the width direction, and the register camera is disposed on a center side of the web in the width direction.

According to this configuration, the pair of fan out cameras can be disposed at both end sides of the web in the width direction where the influence of fan out is large, and the register camera can be disposed at the center side of the web in the width direction where the influence of fan out is small. Therefore, based on the pair of register marks printed on the both end sides of the web, it is possible to suitably correct fan out having a large influence. Moreover, since register movement can be corrected based on the register mark printed on the center side of the web and the pair of register marks printed on the both end sides of the web, register movement can be suitably corrected.

Advantageously, the lateral register correcting device further includes: a pair of detection cameras disposed on the front side and the back side of the web with the web interposed therebetween and capable of detecting the register mark; and a camera moving unit for moving the detection camera in the width direction of the web. The register detection and estimation unit includes a register correction amount deriving unit that derives the register correction amount from the register mark detected by each of the pair of detection cameras moved to a center side of the web in the width direction, and the fan out detection and estimation unit includes a fan out correction amount deriving unit that derives the fan out correction amount from the register mark detected by each of the pair of detection cameras moved to both end sides of the web in the width direction.

According to this configuration, the pair of detection cameras detect the pair of front side and back side register marks printed on the center side of the web, and based on the detected pair of register marks, register movement by each printing unit can be corrected. Thus, register movement can be corrected with high accuracy.

Moreover, the pair of detection cameras detect the pair of register marks printed on the both end sides of the web, and based on the detected pair of register marks, the width of the web stretched in the width direction can be corrected. Thus, fan out can be corrected with high accuracy. Here, since only a pair of detection cameras need to be disposed, the configuration of the lateral register correcting device can be simplified.

Advantageously, the lateral register correcting device further includes a pair of detection cameras disposed on the front side and the back side of the web with the web interposed therebetween and disposed on both end sides of the web in the width direction, and capable of detecting the register mark. The register detection and estimation unit includes a register correction amount deriving unit that derives the register correction amount from the register mark detected by each of the pair of detection cameras, and the fan out detection and estimation unit includes a fan out correction amount deriving unit that derives the fan out correction amount from the register mark detected by each of the pair of detection cameras.

According to this configuration, the pair of detection cameras detect the pair of front side and back side register marks printed on the both end sides of the web, and based on the detected pair of register marks, register movement by each printing unit can be corrected.

Moreover, the pair of detection cameras detect the pair of register marks printed on the both end sides of the web, and based on the detected pair of register marks, the width of the web stretched in the width direction can be corrected. Thus, fan out can be corrected with high accuracy. Here, since only a pair of detection cameras need to be disposed, the configuration of the lateral register correcting device can be simplified.

According to another aspect of the present invention, a printing press includes: a feeder device that draws and feeds the web from a roll; a printing device that includes a plurality of printing units and performs printing on the web drawn out from the feeder device by each of the printing units; a folding machine that cuts the web on which printing has been performed by the printing device; and the lateral register correcting device according to any one of described above.

According to this configuration, using the lateral register correcting device, register movement for a web caused by each printing unit can be suitably corrected, and the width of the web stretched in the width direction can be suitably corrected. Therefore, it is possible to suitably eliminate print misalignment on the web printed by the printing device.

Advantageously, in the printing press, each of the printing units includes a blanket cylinder that makes rotational contact with the web, and a plate cylinder that transfers ink on the blanket cylinder, and the plate cylinder is formed as an integral plate cylinder.

According to this configuration, if the plate cylinder provided in each printing unit is the integral plate cylinder, the correction of register movement and the correction of fan out by the lateral register correcting device can suitably work.

According to still another aspect of the present invention, a lateral register correcting method using the lateral register correcting device according to any one of described above, includes: a register movement correcting step of automatically controlling the register correcting unit by the register correction control unit to correct the register movement for the web; and a fan out correcting step of automatically controlling the fan out correcting unit by the fan out correction control unit to correct the width of the web stretched in the width direction. The fan out correcting step is performed simultaneously with the register movement correcting step or after the register movement correcting step.

According to this configuration, fan out can be corrected after the correction of register movement or simultaneously with the correction of register movement. That is, the correction of register movement and the correction of fan out can be suitably performed by correcting fan out using a state after the correction of register movement as a reference, or by correcting fan out depending on the register movement to be corrected.

Advantageously, in the lateral register correcting method, the register movement correcting step and the fan out correcting step are performed after traveling of the web is stabilized and a tension applied to the web is stabilized.

According to this configuration, when the web is in an unstable state, the register movement correcting step and the fan out correcting step are not performed, thereby preventing unnecessary automatic control from being performed.

### Advantageous Effects of Invention

According to the lateral register correcting device, the printing press, and the lateral register correcting method of the present invention, based on the register marks printed on the front side and the back side of the web, it is possible to correct register movement for the web caused by each printing unit in real time, and to correct the width of the web stretched in the width direction in real time. Thus, it is possible to suitably suppress the occurrence of print misalignment.

### BRIEF DESCRIPTION OF DRAWINGS

FIG. 1 is a schematic diagram showing a web printing press in which a lateral register correcting device of a first embodiment is employed.

FIG. 2 is a partial schematic diagram showing the vicinity of the lateral register correcting device.

FIG. 3 is a pattern diagram of a web where printing has been performed on spaces.

FIG. 4 is an external perspective view showing the vicinity of a roller pressing mechanism.

FIG. 5 is a partial plan view of the vicinity of cameras in the lateral register correcting device of the first embodiment as seen from a transporting direction of a web.

FIG. 6 is a partial plan view of the vicinity of cameras in a lateral register correcting device of a first modified embodiment as seen from a transporting direction of a web.

FIG. 7 is a partial plan view of the vicinity of cameras in a lateral register correcting device of a second modified embodiment as seen from a transporting direction of a web.

FIG. 8 is a partial plan view of the vicinity of cameras in a lateral register correcting device of a second embodiment as seen from a transporting direction of a web.

FIG. 9 is a partial plan view of the vicinity of cameras in a lateral register correcting device of a third embodiment as seen from a transporting direction of a web.

FIG. 10 is a partial plan view of the vicinity of cameras in a lateral register correcting device of a fourth embodiment as seen from a transporting direction of a web.

FIG. 11 is a partial plan view of the vicinity of cameras in a lateral register correcting device of a fifth embodiment as seen from a transporting direction of a web.

FIG. 12 is a partial plan view of the vicinity of cameras in a lateral register correcting device of a sixth embodiment as seen from a transporting direction of a web.

### DESCRIPTION OF EMBODIMENTS

A web printing press in which a lateral register correcting device according to the present invention is employed will be described below with reference to the accompanying drawings. Note that the present invention is not limited to embodiments to be described below. Moreover, constituent elements in the embodiments below include those which can be replaced and easily made by those skilled in the art, or those substantially the same.

### First Embodiment

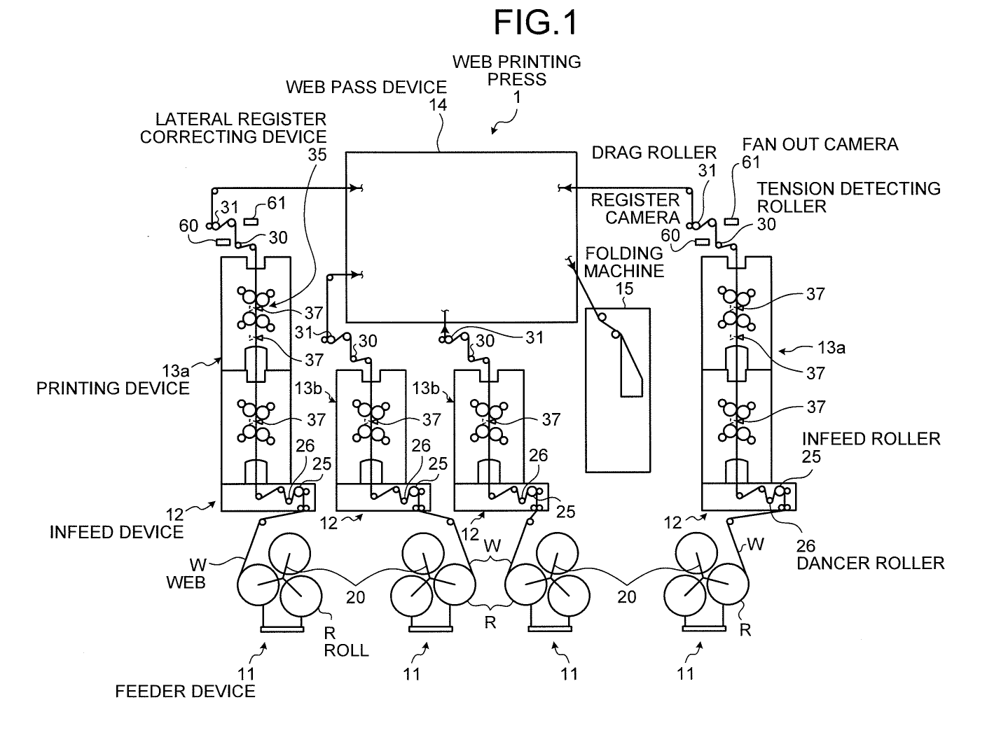

As shown in FIG. 1, a web printing press 1 in the first embodiment is what is called a newspaper web offset printing press. The web printing press 1 is configured by a plurality of feeder devices 11 (four sets in the figure); a plurality of infeed devices 12 (four sets in the figure); a plurality of printing devices 13a and 13b (four sets in the figure); a web pass device 14; and a folding machine 15 provided in this order from an upstream side in the transporting direction of a web W.

Each of the feeder devices 11 is provided with a holding arm 20 holding three rolls R obtained by rolling the webs W into roll shapes. By turning this holding arm 20, the roll R can be set to a paper feeding position. Moreover, each of the feeder devices 11 is provided with a paper splicing device not shown in the figure. If a roll R being drawn out at the paper feeding position starts running out, a roll R at a standby position can be spliced with the roll R at the paper feeding position by this paper splicing device.

Each of the infeed devices 12 is for sending out each web W to the printing device 13a or 13b on the downstream side and for adjusting a tension of the web W. Specifically, the infeed device 12 includes, from an upstream side in the transporting direction of the web W, an infeed roller 25 which is rotatably driven by a drive motor not shown in the figure, and a dancer roller 26 which moves in a direction away from or toward the web W to adjust the tension of the web W. The infeed roller 25 transports the web W to the printing device 13a or 13b on the downstream side by the rotation thereof, and the dancer roller 26 adjusts the tension of the web W by moving in a direction away from or toward the web W. Note that although the first embodiment has a configuration including the dancer roller 26, the dancer roller 26 may be omitted and the present invention is not limited to this configuration.

In the plurality of printing devices 13a and 13b, there are multicolor printing devices 13a each of which performs duplex four-color printing, and two-color printing devices 13b each of which performs duplex two-color printing. The multicolor printing devices 13a and the two-color printing devices 13b can perform predetermined printing on the webs W fed from the respective feeder devices 11. Note that although the printing devices 13a and 13b are configured by the multicolor printing devices 13a and the two-color printing devices 13b in the first embodiment, the printing devices 13a and 13b are not limited to this configuration. Various printing devices may be appropriately combined and used in accordance with a print, for example such as a duplex single color printing device for performing duplex single color printing, and a multicolor printing device for performing one-side four-color or two-color printing.

Although illustration thereof is omitted, the web pass device 14 is provided with a plurality of cutters for cutting the web W in a central portion in the width direction of the web W along the transporting direction of the web W, a number of guide rollers and turn bars for setting transportation routes of the cut webs W, and the like. Therefore, in the web pass device 14, the webs W, on which printing has been performed by the printing devices 13a and 13b, are cut by the cutters, their transportation routes are changed by the turn bars, and the cut webs W are overlapped on one another in a predetermined order.

The folding machine 15 is to fold lengthwise the plurality of overlapped webs W discharged from the web pass device 14, cut widthwise the webs W to have a predetermined length, and further fold widthwise the webs W in order to form a desired signature.

Moreover, between each of the plurality of printing devices 13a and 13b and the web pass device 14, a tension detecting roller 30 for detecting the tension of the web W, and a drag roller 31 for transporting the web W toward the web pass device 14 are disposed in this order from an upstream side in the transporting direction. Although the detail will be described later, between each of the printing devices 13a and the web pass device 14, a pair of register cameras 60 and a pair of fan out cameras 61 are provided on both sides of the web W with the web W interposed therebetween on the downstream side of the tension detecting roller 30.

A sequence of printing operation by the web printing press 1 will now be described. First, if the webs W are fed from the feeder devices 11 to the printing devices 13a and 13b via the infeed devices 12, respectively, four-color printing or two-color printing is performed on the both sides of the web W in each of the printing devices 13a and 13b. Next, the plurality of webs W, which have been printed by the printing devices 7, are cut lengthwise by the cutters in the web pass device 14, their traveling routes are changed, and the cut webs W are overlapped on one another in a predetermined order. Then, when the plurality of webs W overlapped by the web pass device 14 are introduced into the folding machine 15, the plurality of overlapped webs W are folded lengthwise, cut widthwise to have a predetermined length, and folded widthwise in order to make a desired signature. Thereafter, the signature is delivered.

When printing is performed on the web W by the multicolor printing device 13a, register movement such that the print images of the respective colors printed on the web W result in mutual print misalignment in the transporting direction of the web W or in the width direction of the web W may possibly occur. Moreover, when printing is performed on the web W by the printing device 13a or 13b, ink and dampening water are transferred onto the web W, thereby causing a phenomenon called fan out in which the web is stretched in the width direction thereof. When fan out occurs, the web W is stretched in the width direction thereof, thereby resulting in print misalignment. Therefore, in order to correct register movement and correct the web being stretched in the width direction thereof, the web printing press 1 is provided with a lateral register correcting device 35. Note that fan out has a larger stretch amount as approaching to the outer side from the center of the web W in the width direction.

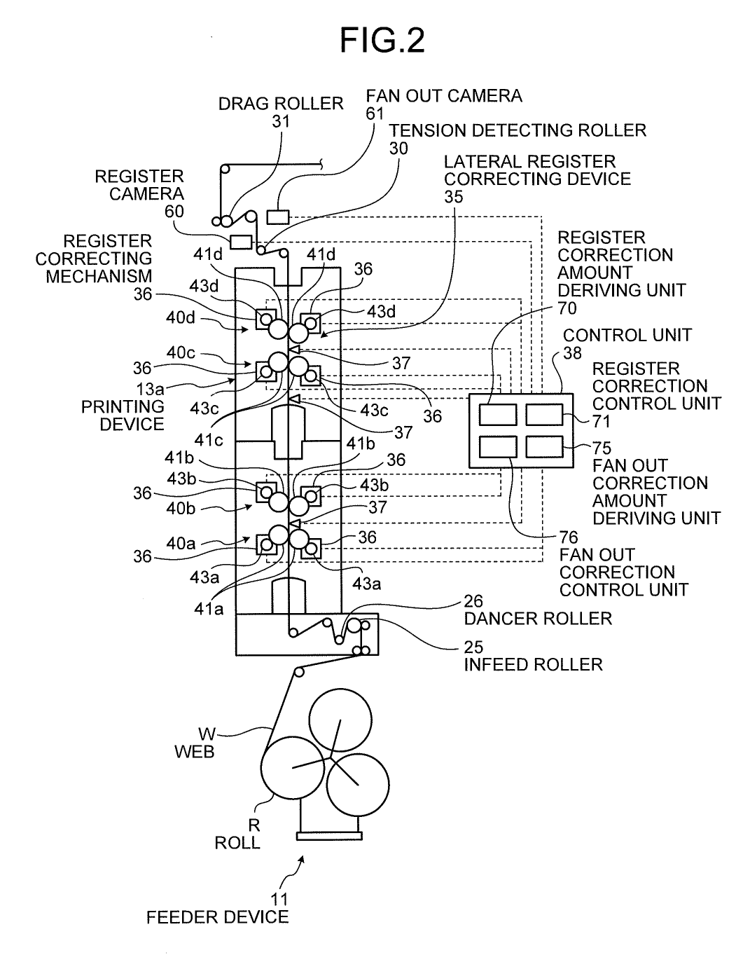

Specifically, with reference to FIG. 2, a configuration of the lateral register correcting device 35 provided in the web printing press 1 will be described. Note that the lateral register correcting device 35 is disposed in each of the printing devices 13a. Thus, the lateral register correcting device 35 will be described taking, as an example, the lateral register correcting device 35 provided in the multicolor printing device 13a shown in the left side of FIG. 1.

As shown in FIG. 2, the lateral register correcting device 35 according to the first embodiment is to correct register movement of the printing device 13a and to correct the width of the web W stretched in the width direction. The lateral register correcting device 35 includes a register correcting mechanism 36 (register correcting means) for correcting register movement of the printing device 13a, and a roller pressing mechanism 37 (fan out correcting means) for correcting the width of the web W stretched in the width direction. The register correcting mechanism 36 and the roller pressing mechanism 37 are controlled by a control unit 38.

Although the register correcting mechanism 36 and the roller pressing mechanism 37 will be described next, since the register correcting mechanism 36 and the roller pressing mechanism 37 are provided inside the printing device 13a, the printing device 13a will be briefly described before describing the register correcting mechanism 36 and the roller pressing mechanism 37.

The printing device positioned on the left side of the figure is the multicolor printing device 13a, and configured by four printing units 40a, 40b, 40c, and 40d of four ink colors of cyan (C), magenta (M), yellow (Y), and black (K). The four printing units 40a, 40b, 40c, and 40d are disposed in such a way that the black printing unit 40a, the cyan printing unit 40b, the magenta printing unit 40c, and the yellow printing unit 40d are disposed in this order from an upstream side in the transporting direction of the web W. Note that the arrangement order of the printing units 40a, 40b, 40c, and 40d is not limited to this, and it may be a desired arrangement order. Each of the printing units 40a, 40b, 40c, and 40d has a configuration capable of simultaneously performing printing on the front side and the back side of the web W. By performing printing on the web W by the respective printing units 40a, 40b, 40c, and 40d, desired prints are obtained on the both sides of the web W after printing.

The printing units 40a, 40b, 40c, and 40d include pairs of blanket cylinders 41a, 41b, 41c, and 41d opposing each other with the web W interposed therebetween, and pairs of plate cylinders 43a, 43b, 43c, and 43d being oppositely in contact with the blanket cylinders 41a, 41b, 41c, and 41d, respectively. Here, the pair of blanket cylinders 41a in the black printing unit 40a and the pair of blanket cylinders 41b in the cyan printing unit 40b are disposed close to each other, and the pair of blanket cylinders 41c in the magenta printing unit 40c and the pair of blanket cylinders 41d in the yellow printing unit 40d are disposed close to each other. Here, the pairs of plate cylinders 43a, 43b, 43c, and 43d are formed as integral plate cylinders. Note that an integral plate cylinder includes plate cylinders having a configuration such that they cannot be separated from each other and moved in the axial direction thereof.

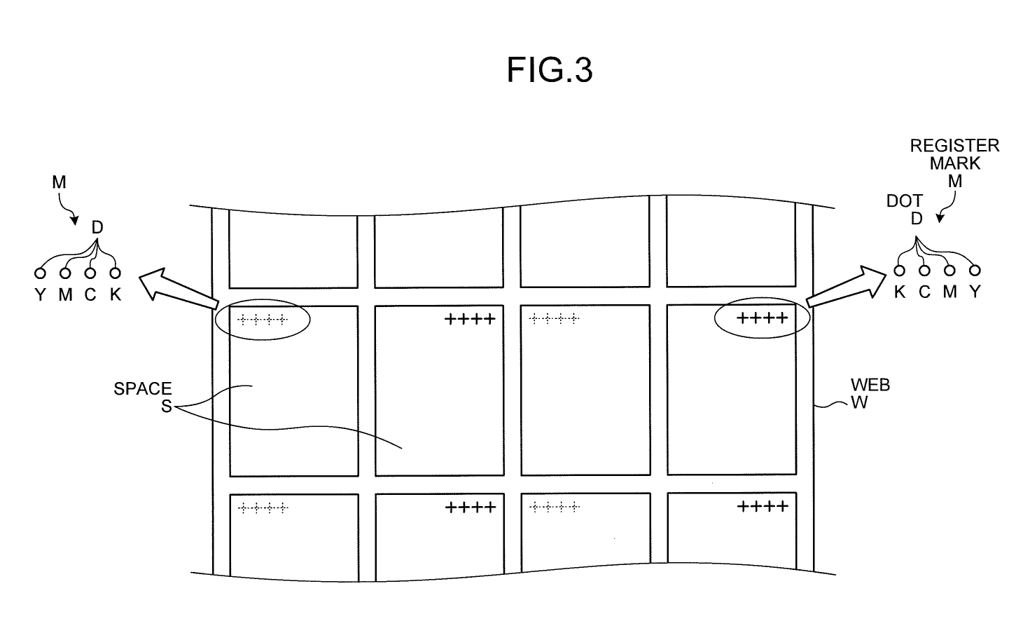

Here, as shown in FIG. 3, according to the multicolor printing device 13a, four pages of spaces S are arranged along the width direction of the web W so that they can be printed. At a corner of each space S, a plurality of register marks M for correcting register movement and fan out are printed. Among the four pages of spaces S arranged along the width direction, the plurality of register marks M are printed on the front side of the first space S and the third space S counting from the right side in the figure, and printed on the back side of the second space S and the fourth space S counting from the right side in the figure. Moreover, the register marks M printed on the first space S and the fourth space S counting from the right side in the figure are positioned at the both ends of the web W, and the register marks M printed on the second space S and the third space S counting from the right side in the figure are positioned at the center part of the web W.

Each of the register marks M is formed by dots D of black (K), cyan (C), magenta (M), and yellow (Y). The register mark M is printed in such a way that black (K), cyan (C), magenta (M), and yellow (Y) are arranged in this order from the inner side to the outer side of the web W. Note that the arrangement order of the CMYK colors is not limited to the arrangement order described above, and it may be any arrangement order.

Next, the register correcting mechanism 36 will be described. The register correcting mechanism 36 is to adjust the respective plate cylinders 43a, 43b, 43c, and 43d in the axial direction and the circumferential direction, and the register correcting mechanism 36 is connected to the control unit 38.

Therefore, if register movement by each of the printing units 40a, 40b, 40c, and 40d occurs in the width direction of the web W, the register correcting mechanisms 36 appropriately move the respective plate cylinders 43a, 43b, 43c, and 43d in the axial direction so as to correct the register movement in the width direction. If register movement by each of the printing units 40a, 40b, 40c, and 40d occurs in the transporting direction of the web W, the register correcting mechanisms 36 appropriately move the respective plate cylinders 43a, 43b, 43c, and 43d in the circumferential direction so as to correct the register movement in the transporting direction.

The roller pressing mechanisms 37 are disposed between the printing unit 40a and the printing unit 40b, between the printing unit 40b and the printing unit 40c, and between the printing unit 40c and the printing unit 40d, respectively.

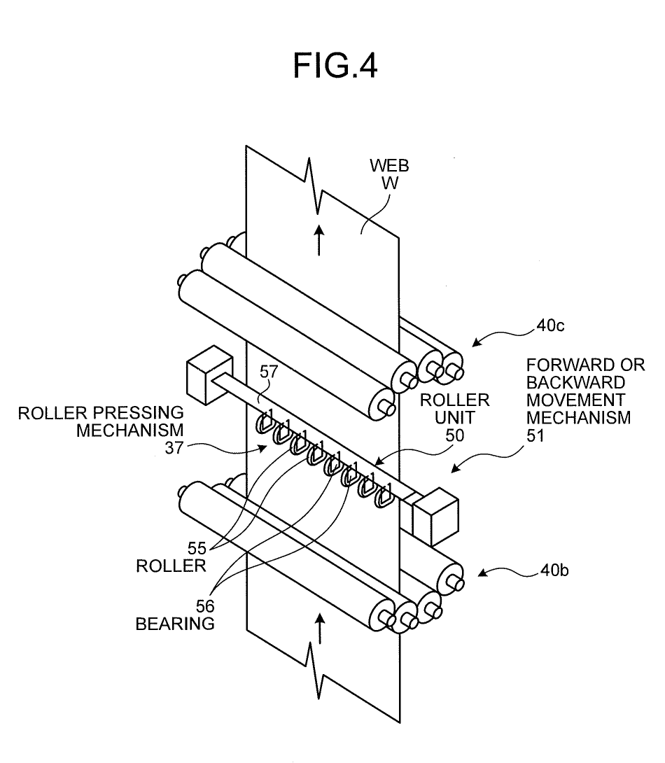

As shown in FIG. 4, the roller pressing mechanism 37 provided between the printing unit 40b and the printing unit 40c corrects the width of the web W stretched in the width direction by making part of the web W project in the width direction thereof. Note that since the roller pressing mechanism 37 between the printing unit 40a and the printing unit 40b and that between the printing unit 40c and the printing unit 40d are similar to the roller pressing mechanism 37 provided between the printing unit 40b and the printing unit 40c, the description thereof will be omitted. The roller pressing mechanism 37 has a roller unit 50 provided over the entire range of the web W in the width direction, and a forward or backward movement mechanism 51 for moving the roller unit 50 forward or backward in a direction away from or toward the web W.

The roller unit 50 is configured by a plurality of rollers 55 disposed at regular intervals on the same axis, a plurality of bearings 56 pivotally supporting the respective rotation axes of the rollers 55, and a roller plate 57 to which the plurality of bearings 56 are fixed. The roller plate 57 is formed in a rectangular shape as seen in a plan view, and disposed with the longitudinal direction thereof coinciding with the width direction of the web W. The plurality of rollers 55 are disposed with the axial directions thereof coinciding with the width direction of the web W. The plurality of bearings 56 are disposed at regular intervals in the longitudinal direction of the roller plate 57. Moreover, the forward or backward movement mechanism 51 is connected to the control unit 38 described above, and the control unit 38 controls the forward or backward movement mechanism 51 to move the roller plate 57 forward or backward in a direction away from or toward the web W.

Therefore, when the web W is being stretched in the width direction thereof, the roller pressing mechanism 37 moves the roller unit 50 forward to the web W using the forward or backward movement mechanism 51, thereby thrusting the plurality of rollers 55 into the web W. When the web W is thrust by the plurality of rollers 55, a plurality of protruding surfaces are formed on the web W, thereby obtaining the wave-shaped web W. Thus, the web W stretched in the width direction contracts in the width direction, thereby being able to correct the width of the web W to be that before printed. That is, it is possible to correct fan out. Note that as a protruding amount in the protruding surfaces formed on the web W by the plurality of rollers 55 is larger, a contraction amount in the web W becomes larger. Thus, it is possible to correct a web W having a large stretch amount in the width direction.

Now, the register correcting mechanism 36 corrects register movement based on a register correction amount derived by the control unit 38, and the roller pressing mechanism 37 corrects fan out based on a fan out correction amount derived at the control unit 38. At this time, the register correction amount is derived based on the register marks M detected by the pair of register cameras 60 disposed between the printing device 13a and the web pass device 14. The fan out correction amount is derived based on the register marks M detected by the pair of fan out cameras 61 disposed between the printing device 13a and the web pass device 14. Hereinafter, a configuration for deriving a register correction amount and a configuration for deriving a fan out correction amount will be specifically described.

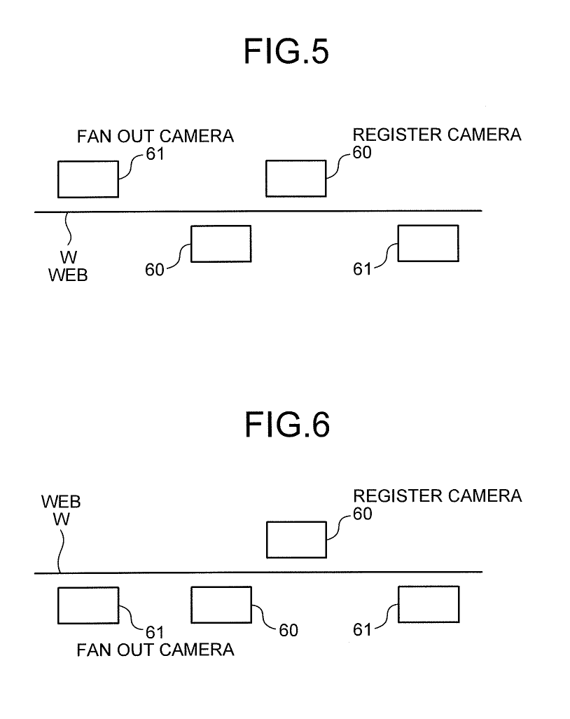

As shown in FIG. 5, the pair of register cameras 60 are disposed so as to face the front side and the back side of the web W, respectively, with the web W interposed therebetween, and disposed at central portions of the web W in the width direction. The pair of register cameras 60 are disposed so as to respectively detect the register mark M on the second space and the register mark M on the third space counting from the right side in the figure, which are printed on the web W. The pair of register cameras 60 are connected to the control unit 38, and positional information of the respective dots D for the pair of register marks M detected by the pair of register cameras 60 is inputted to the control unit 38.

The control unit 38 includes a register correction amount deriving unit 70 for deriving a register correction amount to correct register movement based on positional information about the respective dots D of the pair of register marks M inputted by the pair of register cameras 60, and a register correction control unit 71 for automatically controlling (for example, feedback controlling) the register correcting mechanism 36 in real time based on the register correction amount derived by the register correction amount deriving unit 70. Note that the register correction amount deriving unit 70 derives, using the dot D of black (K) as a reference, a difference between the dot D of black (K) and the dot D of cyan (C), a difference between the dot D of black (K) and the dot D of magenta (M), and a difference between the dot D of black (K) and the dot D of yellow (Y) based on the inputted positional information about the respective dots D of the pair of register marks M. A positional misalignment amount between the derived difference and a preset set difference is equal to a register correction amount.

Therefore, if the pair of register cameras 60 detect the pair of register marks M, the detected pair of register marks M are inputted to the register correction amount deriving unit 70 of the control unit 38. The register correction amount deriving unit 70 derives a register correction amount based on the inputted positional information about the respective dots D of the pair of register marks M. When the register correction amount is derived, the register correction control unit 71 performs feedback control of the register correcting mechanism 36 based on the register correction amount, thereby appropriately correcting register movement for the web W by each of the printing units 40a, 40b, 40c, and 40d. Thus, register detection and estimation means according to claims is formed by the pair of register cameras 60 and the register correction amount deriving unit 70.

On the other hand, the pair of fan out cameras 61 are disposed so as to face the front side and the back side of the web W with the web W interposed therebetween, respectively, and disposed at both ends of the web W in the width direction, respectively. The pair of fan out cameras 61 are disposed so as to respectively detect the register mark M on the first space and the register mark M on the fourth space counting from the right side in the figure, which are printed on the web W. The pair of fan out cameras 61 are connected to the control unit 38, and positional information about the respective dots D for the pair of register marks M detected by the pair of fan out cameras 61 is inputted to the control unit 38.

The control unit 38 includes a fan out correction amount deriving unit 75 for deriving a fan out correction amount to correct fan out based on positional information about the respective dots D for the pair of register marks M inputted by the pair of fan out cameras 61, and a fan out correction control unit 76 for automatically controlling (for example, feedback controlling) the roller pressing mechanism 37 in real time based on the fan out correction amount derived by the fan out correction amount deriving unit 75. Note that the fan out correction amount deriving unit 75 derives, using the dot D of black (K) as a reference, a difference between the dot D of black (K) and the dot D of cyan (C), a difference between the dot D of black (K) and the dot D of magenta (M), and a difference between the dot D of black (K) and the dot D of yellow (Y) based on the inputted positional information about the respective dots D of the pair of register marks M. A positional misalignment amount between the derived difference and a preset set difference is a fan out correction amount, and the fan out correction control unit 76 controls the roller pressing mechanism 37 by a forward or backward movement amount of the roller pressing mechanism 37 corresponding to the fan out correction amount.

Therefore, if the pair of fan out cameras 61 detect the pair of register marks M, the detected pair of register marks M are inputted to the fan out correction amount deriving unit 75 of the control unit 38. The fan out correction amount deriving unit 75 derives a fan out correction amount based on the inputted positional information about the respective dots D of the pair of register marks M. When the fan out correction amount is derived, the fan out correction control unit 76 performs feedback control of the roller pressing mechanism 37 based on the fan out correction amount, thereby appropriately correcting the width of the web W stretched in the width direction. Thus, fan out detection and estimation means according to claims is formed by the pair of fan out cameras 61 and the fan out correction amount deriving unit 75.

Next, a series of controls regarding correction of register movement and fan out by the above-described lateral register correcting device 35 will be described. The correction of register movement and fan out by the lateral register correcting device 35 is performed after the traveling of the web W is stabilized at a predetermined speed, and a tension applied to the traveling web W is also stabilized.

First, the web printing press 1 starts test printing for the web W which has been passed therethrough. When the web W is stabilized, the lateral register correcting device 35 corrects register movement for the web W by each of the printing units 40a, 40b, 40c, and 40d (register movement correcting step). After the lateral register correcting device 35 performs the register correcting step, the width of the web W stretched in the width direction is corrected (fan out correcting step). When the web printing press 1 starts actual printing, the lateral register correcting device 35 performs the fan out correcting step while mainly performing the register correcting step.

According to the above-described configuration, the pair of register cameras 60 detect a pair of front side and back side register marks M which are printed at central portions of the web W, and the lateral register correcting device 35 can correct register movement for the web W by each of the printing units 40a, 40b, 40c, and 40d in real time based on the detected pair of front side and back side register marks M. Thus, the lateral register correcting device 35 can correct register movement by each of the printing units 40a, 40b, 40c, and 40d with high accuracy, and it is possible to suppress the occurrence of print misalignment for the web W. Moreover, the pair of fan out cameras 61 detect a pair of front side and back side register marks M which are printed at both ends of the web W, and the lateral register correcting device 35 can correct the width of the web W stretched in the width direction in real time based on the detected pair of front side and back side register marks M. Thus, the lateral register correcting device 35 can correct fan out occurring in the web W with high accuracy, and it is possible to suppress the occurrence of print misalignment for the web W. Moreover, by disposing the pair of register cameras 60 and the pair of fan out cameras 61 on the front side and the back side of the web W, respectively, register movement and fan out can be corrected in consideration of print misalignment occurring on the front side and the back side of the web.

Furthermore, by disposing the pair of fan out cameras 61 at both ends of the web W and disposing the pair of register cameras 60 at central portions of the web W, the pair of fan out cameras 61 can be disposed at both ends of the web W where the influence of fan out is large, and the pair of register cameras 60 can be disposed at central portions of the web W where the influence of fan out is small. Therefore, the lateral register correcting device 35 can correct register movement using the register correcting mechanism 36 at an area where the influence of fan out is small, and can correct an area where the influence of fan out is large using the roller pressing mechanism 37. Thus, the lateral register correcting device 35 can suitably correct register movement, and can suitably correct fan out.

Moreover, after correcting register movement for the web W by each of the printing units 40a, 40b, 40c, and 40d, the width of the web W stretched in the width direction is corrected, thereby allowing fan out to be corrected using a state after the correction of the register movement as a reference. Therefore, it is possible to suitably perform the correction of register movement and the correction of fan out. Note that although fan out is corrected after the correction of register movement in the first embodiment, the present invention is not limited thereto. Fan out may be corrected simultaneously with the correction of register movement. According to this configuration, since fan out can be corrected based on the correction of register movement, it is possible to suitably perform the correction of register movement and the correction of fan out.

Note that although the correction of register movement and the correction of fan out are performed by feedback control in the first embodiment, if they can be automatically controlled in real time, predictive control, for example, may be used. Furthermore, feedback control and predictive control may be combined together. For example, it may be configured such that feedback control is performed on a steady basis as main control, and predictive control is performed as sub control as necessary.

Moreover, although the pair of fan out cameras 61 are disposed on the front side and the back side of the web W in the lateral register correcting device 35 of the first embodiment, respectively, the pair of fan out cameras 61 may be disposed on one side of the web W as shown in FIG. 6 as a first modified embodiment. In this case, the side on which the pair of fan out cameras 61 are disposed needs to be a multicolor printing side.

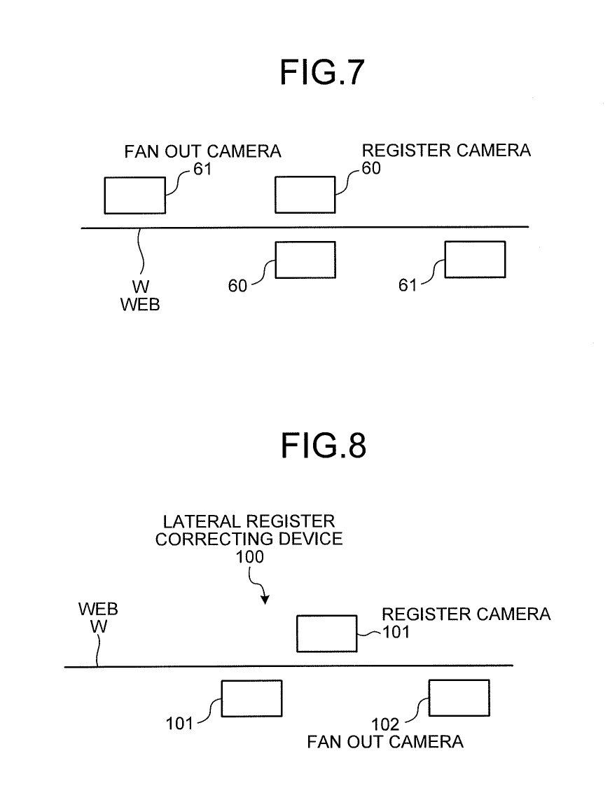

Furthermore, although the pair of front side and back side register cameras 60 are disposed so as to be shifted from each other in the width direction of the web W in the lateral register correcting device 35 of the first embodiment, the pair of front side and back side register cameras 60 may be disposed at the same position in the width direction of the web W as shown in FIG. 7 as a second modified embodiment. In this case, it is necessary to print the resister marks M so as to be printed on a space of the web W at the same position on the front side and the back side of the web W. According to this configuration, register movement on the front side of the web W and that on the back side of the web W can be corrected using the same condition, and it is therefore possible to suitably correct the register movement on the front side and the back side of the web. Moreover, by disposing the pair of register cameras 60 at substantially the same position in the width direction on the front side and the back side, it is possible to perform correction in a way such that a fan out correction amount derived by using the fan out camera 61 disposed on one side of the web W is equal to that about the other side of the web W. That is, fan out correction amounts on the front side and the back side of the web W can be made equal to each other. Thus, fan out can be corrected with high accuracy.

### Second Embodiment

Next, with reference to FIG. 8, a lateral register correcting device 100 according to a second embodiment will be described. In order to avoid redundant description, only different parts will be described. In the lateral register correcting device 35 according to the first embodiment, register movement and fan out are corrected by using the pair of register cameras 60 and the pair of fan out cameras 61. In the lateral register correcting device 100 according to the second embodiment, however, a pair of register cameras 101 and a single fan out camera 102 are used to correct register movement and fan out.

Specifically, as in the first embodiment, the pair of register cameras 101 are disposed on the front side and the back side of web W, respectively, with the web W interposed therebetween at central portions of the web W in the width direction. The single fan out camera 102 is disposed at one end of the web W in the width direction. In this case, the side on which the single fan out camera 102 is disposed needs to be a multicolor printing side. According to this configuration, the lateral register correcting device 100 can detect a pair of front side and back side register marks M, which are printed at central portions of the web W, using the pair of register cameras 101, and can correct register movement for the web W by each of the printing units 40a, 40b, 40c, and 40d in real time based on the detected pair of front side and back side register marks M. On the other hand, the lateral register correcting device 100 can detect a register mark M printed at one end of the web W using the single fan out camera 102, and the lateral register correcting device 100 can correct the width of the web W stretched in the width direction in real time based on the detected register mark M. At this time, the fan out correction amount deriving unit 75 derives a fan out correction amount at the one end of the web W based on the inputted register mark M at the one end, and uses the derived fan out correction amount as a fan out correction amount at the other end of the web W. Thus, as compared to the configuration of the first embodiment, the number of fan out cameras 102 can be reduced, thereby reducing the device cost.

### Third Embodiment

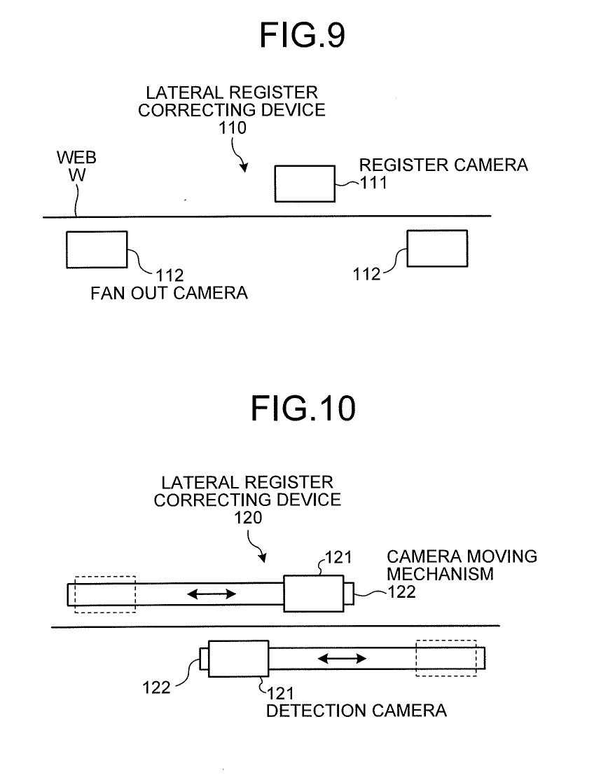

Next, with reference to FIG. 9, a lateral register correcting device 110 according to a third embodiment will be described. In order to avoid redundant description, only different parts will be described. In the lateral register correcting device 35 according to the first embodiment, register movement and fan out are corrected by using the pair of register cameras 60 and the pair of fan out cameras 61. In the lateral register correcting device 110 according to the third embodiment, however, a single register camera 111 and a pair of fan out cameras 112 are used to correct register movement and fan out.

Specifically, the single register camera 111 is disposed on a central portion of the web W in the width direction and on one side of the web W. The pair of fan out cameras 112 are disposed at the both ends of the web W in the width direction and on the other side of the web W. In this case, the side on which the pair of fan out cameras 112 are disposed needs to be a multicolor printing side. According to this configuration, the lateral register correcting device 110 can detect a pair of register marks M which are printed at both ends of the web W using the pair of fan out cameras 112, and can correct the width of the web W stretched in the width direction in real time based on the detected pair of register marks M. On the other hand, the lateral register correcting device 110 detects the register marks M printed at the central portions of the web W using the single register camera 111. Based on the detected pair of register marks M, the lateral register correcting device 110 can correct register movement for one side of the web W by each of the printing units 40a, 40b, 40c, and 40d in real time and correct register movement for the other side of the web W by each of the printing units 40a, 40b, 40c, and 40d in real time using the pair of fan out cameras 112 based on the pair of register marks M printed at the both ends of the web W. Specifically, a register correction amount on the other side of the web W is equal to a value obtained by dividing a difference between an absolute value of a positional misalignment amount of each dot D in the register mark M printed on one end of the web W and an absolute value of a positional misalignment amount of each dot D in the register mark M printed on the other end of the web W by two. Thus, as compared to the configuration of the first embodiment, the number of register cameras 111 can be reduced, thereby reducing the device cost.

### Fourth Embodiment

Next, with reference to FIG. 10, a lateral register correcting device 120 according to a fourth embodiment will be described. In order to avoid redundant description, only different parts will be described. In the lateral register correcting device 35 according to the first embodiment, register movement and fan out are corrected by using the pair of register cameras 60 and the pair of fan out cameras 61. In the lateral register correcting device 120 according to the fourth embodiment, however, a pair of detection cameras 121 disposed on the front side and the back side of the web W, and a pair of camera moving mechanisms 122 for moving the pair of detection cameras 121, respectively, in the width direction of the web W are used to correct register movement and fan out.

Specifically, the pair of detection cameras 121 are configured so as to be movable between the central portion and both ends of the web W in the width direction by the pair of camera moving mechanisms 122. Therefore, if the pair of detection cameras 121 are moved to the central portions of the web W in the width direction, the lateral register correcting device 120 detects a pair of front side and back side register marks M printed on the central portions of the web W using the pair of detection cameras 121, and can correct register movement for the web W by each of the printing units 40a, 40b, 40c, and 40d in real time based on the detected pair of front side and back side register marks M. On the other hand, if the pair of detection cameras 121 are moved to the both ends of the web W in the width direction, the lateral register correcting device 120 detects a pair of front side and back side register marks M printed at the both ends of the web W using the pair of detection cameras 121, and can correct the width of the web W stretched in the width direction in real time based on the detected pair of front side and back side register marks M. Thus, as compared to the configuration of the first embodiment, the number of cameras 121 can be reduced, thereby reducing the device cost.

### Fifth Embodiment

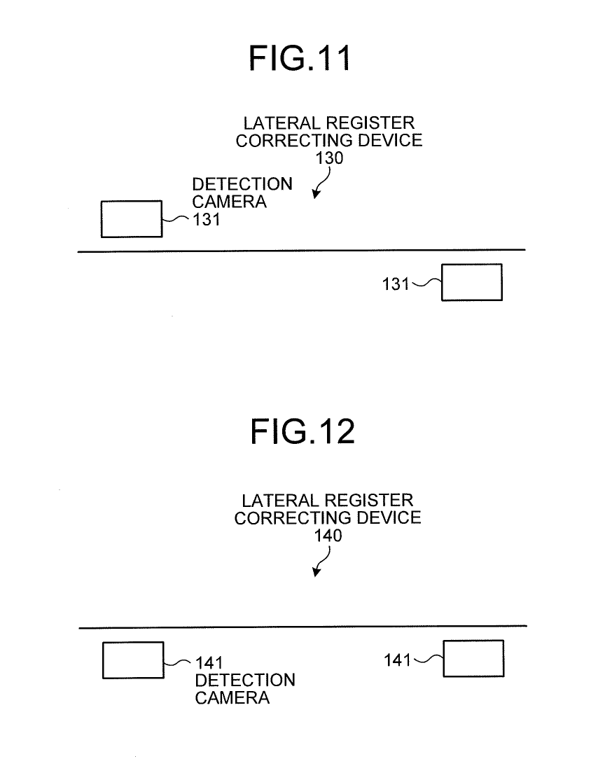

Next, with reference to FIG. 11, a lateral register correcting device 130 according to a fifth embodiment will be described. In order to avoid redundant description, only different parts will be described. In the lateral register correcting device 35 according to the first embodiment, register movement and fan out are corrected by using the pair of register cameras 60 and the pair of fan out cameras 61. In the lateral register correcting device 130 according to the fifth embodiment, however, a pair of detection cameras 131 disposed on the front side and the back side of the web W and disposed at the both ends of the web W are used to correct register movement and fan out.

Specifically, the lateral register correcting device 130 can correct register movement based on a register correction amount obtained by dividing a difference between an absolute value of a positional misalignment amount of each dot D in the register mark M printed on one end of the web W and an absolute value of a positional misalignment amount of each dot D in the register mark M printed on the other end of the web W by two. On the other hand, the lateral register correcting device 130 can correct fan out based on a fan out correction amount obtained by adding an absolute value of a positional misalignment amount of each dot D in the register mark M printed on one end of the web W and an absolute value of a positional misalignment amount of each dot D in the register mark M printed on the other end of the web W and then dividing the obtained value by two. Thus, as compared to the configuration of the first embodiment, the number of cameras 131 can be reduced, thereby reducing the device cost.

### Sixth Embodiment

Finally, with reference to FIG. 12, a lateral register correcting device 140 according to a sixth embodiment will be described. In order to avoid redundant description, only different parts will be described. In the lateral register correcting device 35 according to the first embodiment, register movement and fan out are corrected by using the pair of register cameras 60 and the pair of fan out cameras 61. In contrast, in the lateral register correcting device 140 according to the sixth embodiment, a pair of detection cameras 141 disposed on one side (the front side or the back side) of the web W and disposed at the both ends of the web W are used to correct register movement and fan out. Note that the lateral register correcting device 140 is directed to register movement on one side of the web W (the side on which the pair of detection cameras 141 are provided), and it is not directed to register movement on the other side of the web W. That is, the lateral register correcting device 140 is used, for example, in a case where printing is performed on one side of the web W, and printing is not performed on the other side of the web W.

Specifically, the lateral register correcting device 140 can correct register movement based on a register correction amount obtained by dividing a difference between an absolute value of a positional misalignment amount of each dot D in the register mark M printed on one end of the web W and an absolute value of a positional misalignment amount of each dot D in the register mark M printed on the other end of the web W by two. On the other hand, the lateral register correcting device 140 can correct fan out based on a fan out correction amount obtained by adding an absolute value of a positional misalignment amount of each dot D in the register mark M printed on one end of the web W and an absolute value of a positional misalignment amount of each dot D in the register mark M printed on the other end of the web W and then dividing the obtained value by two. Thus, as compared to the configuration of the first embodiment, the number of cameras 141 can be reduced, thereby reducing the device cost.

### INDUSTRIAL APPLICABILITY

As described above, the lateral register correcting device, the printing press, and the lateral register correcting method according to the present invention are useful for a web printing press in which fan out occurs, and particularly suitable for a newspaper web offset printing press.

1. A lateral register correcting device comprising:
a register correcting unit capable of correcting register movement for the web by each of the printing units, when a plurality of printing units print on a traveling web; and
a fan out correcting unit capable of correcting a width of the web stretched in a width direction, wherein
a register mark for performing correction by the register correcting unit and the fan out correcting unit is printed on the web by each of the printing units,
the lateral register correcting device comprising:
a register detection and estimation unit capable of estimating and detecting a register correction amount by the register correcting unit based on the register mark;
a register correction control unit capable of automatically controlling the register correcting unit in real time based on the register correction amount derived by the register detection and estimation unit;
a fan out detection and estimation unit capable of estimating and detecting a fan out correction amount by the fan out correcting unit based on the register mark; and
a fan out correction control unit capable of automatically controlling the fan out correcting unit in real time based on the fan out correction amount derived by the fan out detection and estimation unit.

2. The lateral register correcting device according to claim 1, wherein the register mark is printed on a front side and a back side of the web.

3. The lateral register correcting device according to claim 2, wherein the register detection and estimation unit includes a pair of register cameras which are disposed on the front side and the back side of the web with the web interposed therebetween and capable of detecting the register mark, and a register correction amount deriving unit that derives the register correction amount from the register mark detected by each of the pair of register cameras, and
the fan out detection and estimation unit includes a pair of fan out cameras which are disposed so as to face the web and capable of detecting the register mark, and a fan out correction amount deriving unit that derives the fan out correction amount from the register mark detected by each of the pair of fan out cameras.

4. The lateral register correcting device according to claim 3, wherein the pair of fan out cameras is disposed on the front side and the back side of the web with the web interposed therebetween.

5. The lateral register correcting device according to claim 3, wherein the pair of fan out cameras are disposed so as to face each other on a side of the web.

6. The lateral register correcting device according to claim 3, wherein the pair of fan out cameras is disposed on both end sides of the web in the width direction, and the pair of register cameras are disposed between the pair of fan out cameras.

7. The lateral register correcting device according to claim 3, wherein the pair of register cameras is positioned at a substantially same position in the width direction of the web.

8. The lateral register correcting device according to claim 3, wherein the pair of register cameras is disposed on a center side of the web in the width direction.

9. The lateral register correcting device according to claim 2, wherein the register detection and estimation unit includes a pair of register cameras which are disposed on the front side and the back side of the web with the web interposed therebetween and capable of detecting the register mark, and a register correction amount deriving unit that derives the register correction amount from the register mark detected by each of the pair of register cameras, and
the fan out detection and estimation unit includes a fan out camera which is disposed so as to face the web and capable of detecting the register mark, and a fan out correction amount deriving unit that derives the fan out correction amount from the register mark detected by the fan out camera.

10. The lateral register correcting device according to claim 9, wherein the fan out camera is disposed at one end side of the web in the width direction, and the pair of register cameras are disposed on a center side of the web in the width direction.

11. The lateral register correcting device according to claim 2, wherein the fan out detection and estimation unit includes a pair of fan out cameras which are disposed so as to face one side of the web and capable of detecting the register mark, and a fan out correction amount deriving unit that derives the fan out correction amount from the register mark detected by each of the pair of fan out cameras, and
the register detection and estimation unit includes a register camera which is disposed so as to face the other side of the web and capable of detecting the register mark, and a register correction amount deriving unit that derives the register correction amount from the register mark detected by each of the register camera and the pair of fan out cameras.

12. The lateral register correcting device according to claim 11, wherein the pair of fan out cameras is disposed on both end sides of the web in the width direction, and the register camera is disposed on a center side of the web in the width direction.

13. The lateral register correcting device according to claim 2, further comprising:
a pair of detection cameras disposed on the front side and the back side of the web with the web interposed therebetween and capable of detecting the register mark; and
a camera moving unit for moving the detection camera in the width direction of the web, and wherein
the register detection and estimation unit includes a register correction amount deriving unit that derives the register correction amount from the register mark detected by each of the pair of detection cameras moved to a center side of the web in the width direction, and
the fan out detection and estimation unit includes a fan out correction amount deriving unit that derives the fan out correction amount from the register mark detected by each of the pair of detection cameras moved to both end sides of the web in the width direction.

14. The lateral register correcting device according to claim 2, further comprising a pair of detection cameras disposed on the front side and the back side of the web with the web interposed therebetween and disposed on both end sides of the web in the width direction, and capable of detecting the register mark, and wherein
the register detection and estimation unit includes a register correction amount deriving unit that derives the register correction amount from the register mark detected by each of the pair of detection cameras, and
the fan out detection and estimation unit includes a fan out correction amount deriving unit that derives the fan out correction amount from the register mark detected by each of the pair of detection cameras.

15. A printing press comprising:
a feeder device that draws and feeds the web from a roll;
a printing device that includes a plurality of printing units and performs printing on the web drawn out from the feeder device by each of the printing units;
a folding machine that cuts the web on which printing has been performed by the printing device; and
the lateral register correcting device according to claim 1.

16. The printing press according to claim 15, wherein each of the printing units includes a blanket cylinder that makes rotational contact with the web, and a plate cylinder that transfers ink on the blanket cylinder, and
the plate cylinder is formed as an integral plate cylinder.

17. A lateral register correcting method using the lateral register correcting device according to claim 1, the method comprising:
a register movement correcting step of automatically controlling the register correcting unit by the register correction control unit to correct the register movement for the web; and
a fan out correcting step of automatically controlling the fan out correcting unit by the fan out correction control unit to correct the width of the web stretched in the width direction, wherein
the fan out correcting step is performed simultaneously with the register movement correcting step or after the register movement correcting step.

18. The lateral register correcting method according to claim 17, wherein the register movement correcting step and the fan out correcting step are performed after traveling of the web is stabilized and a tension applied to the web is stabilized.
